(19) United States
(12) Patent Application Publication
(10) Pub. No.: US 2026/0139707 A1
(43) Pub. Date: May 21, 2026

(54) Pivot Socket For A Hand Truck

(71) Applicant: Magline, Inc., Standish, MI (US)

(72) Inventors: Scott Alexander Bokach, Wyoming, MI (US); Matthew Ryen Ruster, Zeeland, MI (US); Fran Bridges, Midland, MI (US)

(21) Appl. No.: 19/360,595

(22) Filed: Oct. 16, 2025

Related U.S. Application Data
(60) Provisional application No. 63/721,622, filed on Nov. 18, 2024.

(51) Int. Cl. F16C 11/04; B62B 5/00

(52) U.S. Cl. CPC F16C 11/04; B62B 5/00

(57) ABSTRACT

A universal pivot socket for use with a hand truck is disclosed. The pivot socket comprises a main body with a hollow interior accessible through an opening at the top, which is configured to connect directly to the hand truck. Integrally formed with the main body is a flange extending outwardly from one of its vertical faces. The protrusion includes an aperture that extends through its center and is designed to accommodate a connecting element intended to be affixed to the hand truck. The pivot socket is constructed from a plastic, plastic-like, polymer, or polymer-like material, which has a lower hardness level compared to steel or aluminum. This material choice allows for easy sliding between two-wheel and four-wheel modes and prevents the creation of scraps, scratches, or other marks along the aluminum extrusion of the hand truck.

### CROSS-REFERENCE TO RELATED APPLICATION

This application claims the benefit of the priority date of U.S. Provisional Application Ser. No. 63/721,622, filed on Nov. 18, 2024, the contents of that application being incorporated by reference herein in their entirety and for all purposes.

### FIELD OF INVENTION

The present invention generally relates to a hand truck, more specifically, a universal pivot socket used to allow for the transition between two-wheel and four-wheel modes. The present disclosure relates to light material handling equipment. Light material handling equipment encompasses a wide variety of wheeled carts, trollies, and hand trucks (e.g., dollies). These devices are typically manually operated by an operator who pushes or pulls the equipment. There are also motor-assisted (i.e., motorized) devices, which may include some type of device or mechanism to propel the device or cart without the operator having to exert a significant (or even zero) effort to cause the device to move.

### BACKGROUND

In various industries, hand trucks are essential tools for transporting heavy loads efficiently. Traditional hand trucks often rely on metal components, such as pivot sockets, which serve as crucial junctions between different parts of the hand truck. While metal pivot sockets provide the necessary strength and durability, they introduce several challenges that affect the overall performance and longevity of the hand truck.

Generally, it is known to provide a wheeled device that typically stands vertically on two wheels and has an upper portion held by the operator. The operator loads the cargo, then tilts the loaded cargo before wheeling the loaded cargo to a different location. It is also known to provide a hand truck including rear stabilizer wheels, which allow the hand truck to be tilted or leaned back and rested on the primary wheels and the rear stabilizer wheels. There is a wide variety of application-specific hand trucks based upon the above generally known designs. Such known application-specific hand trucks may be known as drum dollies (for moving 55-gallon drums), cylinder trucks (for moving high-pressure gas cylinders), tree dollies (for moving trees with ball roots), and water dollies (for moving multiple 5-gallon tanks of drinking water), to name only a few. It is generally known that any of these examples may be manually operated or may be motor-assisted devices.

It is also generally known that there are a vast number of known hand trucks for many different uses. The known hand trucks vary a great deal and may include simple mechanical clamping mechanisms to secure the load to the truck, as well as to provide for manual braking devices. It is also further known to provide more complex and motorized hand trucks that can lift and lower loads. There are many adaptations and versions of hand trucks to meet the many varying needs of specific uses or applications given that hand trucks can be used in so many ways and in so many industries.

Hand trucks frequently come in differing sizes and heights depending on the needs of the user. Each of these hand trucks often requires different parts to connect handles, components, etc. to construct the hand trucks. However, this common practice often requires multiple parts and is more expensive.

One significant issue with metal pivot sockets is their weight. Metal components, particularly those made from steel or aluminum, add considerable weight to the hand truck. This increased weight can make the hand truck more difficult to maneuver, especially when loaded with heavy items, and can contribute to operator fatigue over extended periods of use. Additionally, the heavier weight of metal components can lead to increased shipping costs and higher energy consumption during transportation and handling.

Another problem associated with metal pivot sockets is their tendency to cause damage to other parts of the hand truck. Metal-on-metal contact, particularly between the pivot socket and the aluminum extrusion (rail), can result in scratches, scrapes, and other forms of wear and tear. These damages not only affect the aesthetic appearance of the hand truck but also reduce its structural integrity over time. The creation of such marks can necessitate more frequent maintenance and part replacements, leading to increased operational costs and downtime.

Furthermore, the manufacturing and material costs of metal pivot sockets can be prohibitive. Metals such as steel and aluminum are generally more expensive than alternative materials, and their processing involves additional steps such as machining, welding, and surface treatments. These factors contribute to higher production costs, which can be a significant concern for manufacturers seeking to produce cost-effective hand trucks without compromising quality.

In response to these challenges, there has been a shift towards using alternative materials, such as plastics and polymers, for pivot sockets. These materials offer potential advantages in terms of weight reduction, cost savings, and reduced wear and tear on other components. However, the transition to non-metal materials introduces its own set of challenges, such as ensuring adequate strength and durability to withstand the rigors of heavy-duty use.

The present invention addresses these issues by providing an improved universal pivot socket design that leverages the benefits of alternative materials while maintaining the necessary performance characteristics required for effective hand truck operation.

Accordingly, an improved component allowing for use on multiple hand trucks is needed in the industry to reduce cost.

### BRIEF DESCRIPTION OF THE DRAWINGS

The operation of the invention may be better understood by reference to the detailed description taken in connection with the following illustrations, wherein:

FIG. 1 illustrates several hand trucks known in the art in varying models;

FIG. 2 illustrates new, novel hand trucks in varying models according to one or more embodiments shown and described herein;

FIG. 3 illustrates a prior art pivot socket for varying hand truck models according to one or more embodiments shown and described herein;

FIG. 4 illustrates an alternative embodiment of a prior art pivot socket for the hand truck according to one or more embodiments shown and described herein;

FIG. 5 illustrates a perspective view of a universal pivot socket according to one or more embodiments shown and described herein;

FIG. 6 illustrates a perspective view of a universal pivot socket with a reflector affixed to a hand truck according to one or more embodiments shown and described herein;

FIG. 7 illustrates a perspective view of a universal pivot socket with an inner sleeve according to one or more embodiments shown and described herein;

FIG. 8 illustrates a perspective view of a universal pivot socket with an inner sleeve according to one or more embodiments shown and described herein; and

FIG. 9 illustrates a perspective view of a universal pivot socket with an inner sleeve according to one or more embodiments shown and described herein.

### DETAILED DESCRIPTION

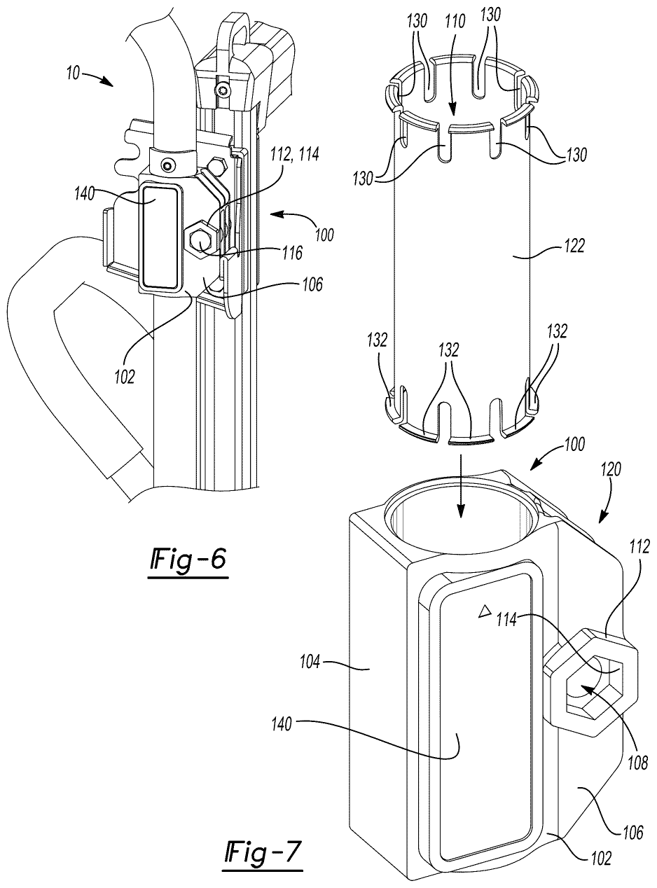

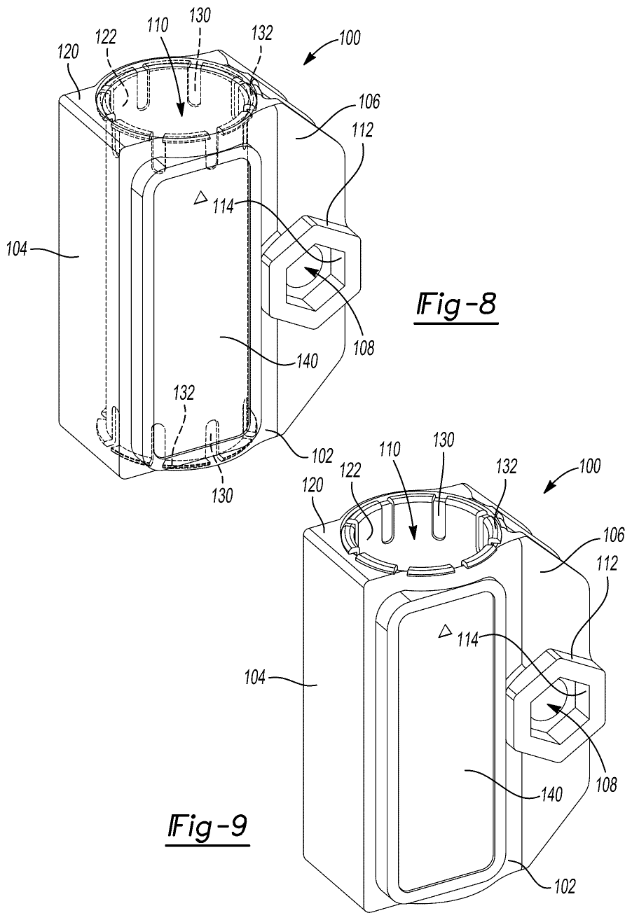

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. For example, the embodiment of the universal pivot socket 100 depicted in FIG. 5 may include a reflector 140, as is shown in the embodiment depicted in FIGS. 6-9. Additionally, the embodiment of the universal pivot socket 100 depicted in FIG. 5 may include a nut pocket 114 as is shown in the embodiment depicted in FIGS. 6-9. As such, the following description is presented by way of illustration only and should not limit in any way the various alternatives and modifications that may be made to the illustrated embodiments and still be within the spirit and scope of the invention.

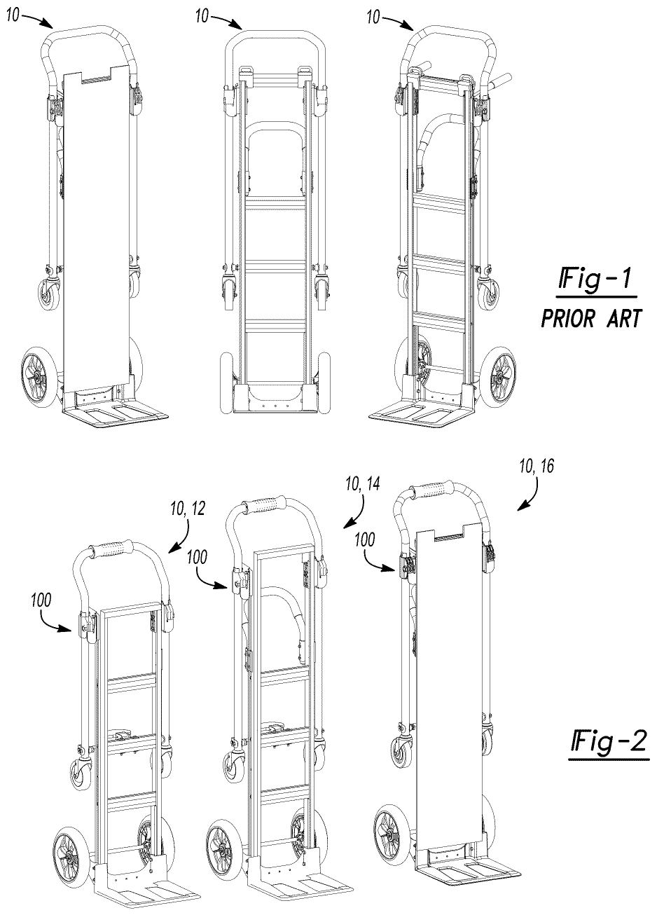

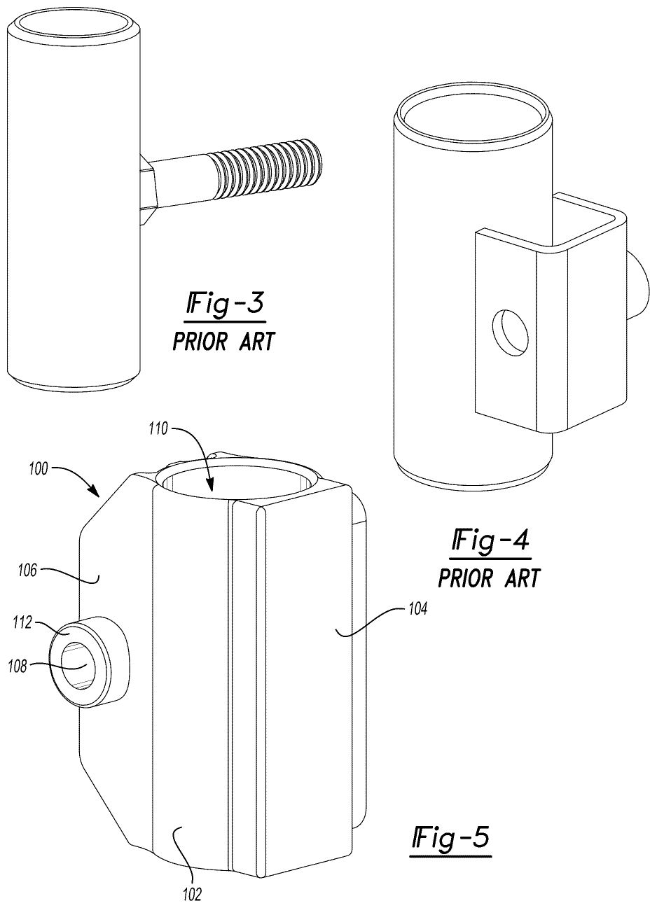

FIGS. 1, 3, and 4 depict the state of the prior art. Specifically, FIG. 1 illustrates hand trucks 10 in varying models with conventional pivot sockets affixed thereto. FIGS. 3-4 illustrate close-up perspective views of the conventional pivot socket.

FIGS. 2 and 5-9 depict an improved universal pivot socket 100, in some figures affixed to hand trucks 10 of various models 12, 14, and 16. The universal pivot socket 100 may be constructed from a durable material suitable for the intended application, which may include metals, plastics, or composite materials. The universal pivot socket 100 may be made of a plastic, plastic-like, polymer, polymer-like, or similar material, providing for an improvement over metal fabrications in weight and cost. The use of plastic, polymers, or the like in place of metal materials provides for improved installation and removal, as plastic materials and the like tend to slide better than those of metal. Specifically, the use of plastic, polymers, or the like allows for easy sliding between the two-wheel and four-wheel modes. The plastic, polymers, or the like has a lower hardness level than steel or aluminum, which is traditionally used. This material with a lower hardness level benefits the hand truck 10 design by reducing or eliminating scraps, scratches, or other marks along the aluminum extrusion (rail), thereby increasing longevity of the hard truck 10.

As used herein, the terms “plastic,” “plastic-like”, “polymer,” or “polymer-like” broadly encompass all natural, synthetic, and semi-synthetic polymeric substances, including homopolymers, copolymers, blends, composites, laminates, derivatives, and equivalents thereof. Such materials may include, without limitation, thermoplastics, thermosets, elastomers, bio-based and biodegradable polymers, functional polymers, and any polymeric materials hereafter developed. Unless expressly stated otherwise, these terms are intended to be construed in their broadest sense to cover all polymeric materials suitable for the described application. Preferably, the universal pivot socket 100 is made of nylon, glass-filled nylon, carbon fiber reinforced plastics, polypropylene, thermoplastic polyurethane, specially compounded thermoplastics, such as EMS Grivory GVL-6H and GVX65H, or the like.

FIG. 5 illustrates a 1-piece embodiment of the universal pivot socket. The universal pivot socket 100 may comprise a generally rectangular main body 102, 104 (although the side walls may be at least partially curved) with a flange 106 extending from one of its sides. The main body 102, 104 is configured with a hollow interior, as indicated by the opening 110 at the top of the main body 102, 104.

The flange 106 may be integrally formed with the main body 102, 104 and extens outwardly from one of its vertical faces. The flange 106 may have a curved or angled profile; may be generally planar; may adopt any shape that accommodates the hand truck 10 or the connecting element intended to be fixed thereto; or a combination thereof. This flange 106 includes an aperture 108 that extends perpendicularly through a planar surface of the flange 106. The aperture 108 may be centrally located along the longitudinal length of the flange 106. The aperture 108 is designed to accommodate a a fastener (not shown). The design of the main body 102, 104 and the flange 106 ensures structural integrity while allowing for efficient functionality.

The aperture 108 may be at least partially encircled by a rib 122. The rib 112 may completely encircle the circumference of the aperture 108. The rib 122 may have a thickness that extends perpendicularly from the planar surface of the flange 106. The rib 122 may protect a fastener (not shown) secured therethrough and/or provide for a stronger connection between the hand truck 10 and the connecting element intended to be affixed thereto, given the increased surface area of the flange 106 and the corresponding increased material strength associated with materials of thicker widths.

The opening 110 at the top of the main body 102, 104 may allow for access to the internal cavity of the main body 104, which may be utilized for various purposes depending on the specific application of the apparatus. The opening 110 may connect directly to a hand truck 10 of varying models 12, 14, 16, including but not limited those shown in FIG. 2. The opening 110 may be generally cylindrical in shape or any other shape that accommodates the hand truck 10 or the connecting element intended to be affixed thereto. FIGS. 6-9 depict a second embodiment of the universal pivot socket 100, in some figures affixed to a hand truck 10. This second embodiment includes the universal pivot socket 100 as a two-piece design. The two-piece design of the universal pivot socket 100 includes an outer socket 120 and an inner sleeve 122.

The outer socket 120 and the inner sleeve 122 may be constructed from a durable material suitable for the intended application, which may include metals, plastics, or composite materials. The outer socket 120 and the inner sleeve 122 may be made of a plastic, plastic-like, polymer, polymer-like, or similar material, providing for an improvement over metal fabrications in weight and cost. The use of plastic, polymers, or the like in place of metal materials provides for improved installation and removal, as plastic materials and the like tend to slide better than those of metal. Specifically, the use of plastic, polymers, or the like allows for easy sliding between the two-wheel and four-wheel modes. The plastic, polymers, or the like has a lower hardness level than steel or aluminum, which is traditionally used. This material with a lower hardness level benefits the hand truck 10 design by reducing or eliminating scraps, scratches, or other marks along the aluminum extrusion (rail), thereby increasing longevity of the hard truck 10.

As used herein, the terms “plastic,” “plastic-like”, “polymer,” or “polymer-like” broadly encompass all natural, synthetic, and semi-synthetic polymeric substances, including homopolymers, copolymers, blends, composites, laminates, derivatives, and equivalents thereof. Such materials may include, without limitation, thermoplastics, thermosets, elastomers, bio-based and biodegradable polymers, functional polymers, and any polymeric materials hereafter developed. Unless expressly stated otherwise, these terms are intended to be construed in their broadest sense to cover all polymeric materials suitable for the described application. The outer socket 120 and the inner sleeve 122 may be made of nylon, glass-filled nylon, carbon fiber reinforced plastics, polypropylene, thermoplastic polyurethane, specially compounded thermoplastics, such as EMS Grivory GVL-6H and GVX65H, or the like. The outer socket 120 and the inner sleeve 122 may be made of a same material. The outer socket 120 and the inner sleeve 122 may be made of different materials. Preferably, the outer socket 120 may be made of metal and the inner sleeve 122 may be made of a plastic, plastic-like, polymer, polymer-like, or similar material.

The outer socket 120 may comprise a generally rectangular main body 102, 104 (although the side walls may be at least partially curved) with a flange 106 extending from one of its sides. The main body 102, 104 is configured with a hollow interior that is adapted to receive the inner sleeve 122 therein. The outer socket 120 may be integrally formed.

The flange 106 may be integrally formed with the main body 102, 104 and extend outwardly from one of its vertical faces. The flange 106 may have a curved or angled profile; may be generally planar; may adopt any shape that accommodates the hand truck 10 or the connecting element intended to be affixed thereto; or a combination thereof. This flange 106 includes an aperture 108 that extends perpendicularly through a planar surface of the flange 106. The aperture 108 may be centrally located along the longitudinal length of the flange 106. The aperture 108 is designed to accommodate a connecting element, such as a fastener 116. The design of the main body 102, 104 and the flange 106 ensures structural integrity while allowing for efficient functionality.

The aperture 108 may be at least partially encircled by a rib 112. The rib 112 may completely encircle the circumference of the aperture 108. The rib 112 may have a thickness that extends perpendicularly from the planar surface of the flange 106. The rib 112 may protect a fastener 116 secured therethrough and/or provide for a stronger connection between the hand truck 10 and the connecting element intended to be affixed thereto, given the increased surface area of the flange 106 and the corresponding increased material strength associated with materials of thicker widths. The rib 112 may be adapted to hold a nut of a fastener 116. Preferably, the rib 112 may be reciprocally shaped to the nut of a fastener 116, as such, the rib 112 may define a nut pocket 114.

The inner sleeve 122 may be any reciprocal shape to the interior of the outer socket 120, to the exterior shape of the connecting element intended to be affixed to the hand truck 10, or both. Preferably, the inner sleeve 122 is generally cylindrical in shape. The inner sleeve may have an opening 100 extending therethrough. The inner sleeve may be adapted to be inserted into the outer socket 120. The inner sleeve 122 may be adapted to be tension fit within the outer socket 120. The inner sleeve 122 may be integrally formed.

The inner sleeve 122 may have one or more flexing portions 130, preferably, a plurality of flexing portions 130. The one or more flexing portions 130 may be located along one or both distal ends of the inner sleeve 122. The one or more flexing portions 130 are adapted to allow the diameter of the inner sleeve 122 to fluctuate without breaking. The one or more flexing portions 130 may be formed as a cutout that allows a portion of the diameter or all of the diameter of the inner sleeve 122 to expand or contract.

The inner sleeve 122 may contain one or more retention tabs 132. The one or more retention tabs 132 may be located along one or both distal ends of the inner sleeve 122. The one or more retention tabs 132 may be adapted to maintain the position of the inner sleeve 122 within the outer socket 120 once inserted therein. The one or more retention tabs 132 may be formed as a projection that projects radially outward from the longitudinal axis of the inner sleeve 122. When the inner sleeve 122 is inserted into the outer socket 120, the one or more retention tabs 132 may engage one or both distal ends of the outer socket 120 such that the one or more retention tabs 132 at least partially extend past the one or both distal ends of the outer socket 120.

The opening 110 may allow for access to the internal cavity of the inner sleeve 122. The internal cavity of the inner sleeve 122 may be utilized for various purposes depending on the specific application of the apparatus. The opening 110 may connect directly to a hand truck 10 of varying models 12, 14, 16, including but not limited to those shown in FIG. 2. The opening 110 may be generally cylindrical in shape or any other shape that accommodates the hand truck 10 or the connecting element intended to be affixed thereto.

In some embodiments, a reflector 140 may be provided to the main body 102, 104 of the universal pivot socket 100 as is shown in FIGS. 6-9. This reflector 140 enhances the visibility of the hand truck, especially in low-light conditions or during nighttime use. The reflector 140 can be made from various materials, including reflective tape or plastic, and can be attached using adhesive or fasteners. By incorporating a reflector 140, the universal pivot socket 100 not only improves the functionality of the hand truck 10 but also contributes to the safety of the user, reducing the risk of accidents in poorly lit environments.

Regardless of the embodiment, the universal design of the universal pivot socket 100 is adapted to be compatible with numerous portions of a variety of hand truck models in order to affix a large range of connecting elements intended to be affixed to the hand truck. The universal design provides for simplified manufacturing and simplified replacement of parts, if required. Furthermore, the universal design allows a user to be able to use the same universal pivot socket along many portions of a hand truck, across many models of hand trucks, and to affix a large variety of connecting elements.

The embodiments are illustrative of the principles of the disclosure and are not intended to limit the scope of the claims. Various modifications and adaptations may be made without departing from the spirit and scope of the invention.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications, and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit, provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the disclosure of a range in terms of at “‘x’ parts by weight of the resulting polymeric blend composition” also contemplates a teaching of ranges of the same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements, ingredients, components, or steps that do not materially affect the basic and novel characteristics of the combination. The use of the terms “comprising” or “including” to describe combinations of elements, ingredients, components, or steps herein also contemplates embodiments that consist essentially of, or even consist of, the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A universal pivot socket for use with a hand truck, comprising:
a main body having a hollow interior accessible through an opening at a top of the main body, the opening configured to connect directly to the hand truck;
a flange integrally formed with the main body and extending outwardly from a vertical face of the main body, the flange configured to accommodate a connecting element;
wherein the flange includes an aperture extending perpendicularly through a planar surface of the flange; and
wherein the aperture is configured to accommodate a fastener.

2. The universal pivot socket of claim 1, wherein the universal pivot socket is made of a thermoplastic urethane material, the thermoplastic urethane having a lower hardness level than steel or aluminum, thereby allowing for easy sliding between two-wheel and four-wheel modes and preventing the creation of scraps, scratches, or other marks along the aluminum extrusion of the hand truck.

3. The universal pivot socket of claim 1, wherein the universal pivot socket is made of nylon or glass-filled nylon.

4. The universal pivot socket of claim 1, wherein the universal pivot socket is made of carbon reinforced plastics, carbon reinforced polypropylene, or carbon reinforced thermoplastic polyurethane.

5. The universal pivot socket of claim 1, wherein the universal pivot socket further includes a reflector on the main body of the universal pivot socket, the reflector being made from reflective materials and attached using adhesive or fasteners, to enhance the visibility of the hand truck in low-light conditions or during nighttime use, thereby improving safety for the user.

6. The universal pivot socket of claim 1, wherein the circumference of the aperture is at least partially surrounded by a rib;
wherein the rib has a thickness that extends perpendicularly from the planar surface of the flange; and
wherein the rib is adapted to protect at least a portion of the fastener.

7. A universal pivot socket for use with a hand truck, comprising:
an inner sleeve, the inner sleeve having a hollow interior accessible through an opening at a top of the inner sleeve, the hollow interior of the inner sleeve adapted to connect directly to the hand truck; and
an outer socket, the outer socket further comprising:
a main body, the main body having a hollow interior adapted to receive the inner sleeve therein; and
a flange integrally formed with the main body and extending outwardly from a vertical face of the main body, the flange configured to accommodate a connecting element;
wherein the flange includes an aperture extending perpendicularly through a planar surface of the flange; and
wherein the aperture is configured to accommodate a fastener.

8. The universal pivot socket of claim 7, wherein the outer socket, the inner sleeve, or both are made of a metal, plastic, plastic-like, polymer, polymer-like, or composite material; and
wherein the outer socket is made of a same or a different material than the inner sleeve.

9. The universal pivot socket of claim 8, wherein the outer socket is made of metal, and the inner sleeve is made of the plastic, plastic-like, polymer, polymer-like, or similar, material.

10. The universal pivot socket of claim 9, wherein the plastic, plastic-like, polymer, or polymer-like materials include nylon or glass-filled nylon.

11. The universal pivot socket of claim 9, wherein the plastic, plastic-like, polymer, or polymer-like materials include carbon reinforced plastics, carbon reinforced polypropylene, or carbon reinforced thermoplastic polyurethane.

12. The universal pivot socket of claim 7, wherein the universal pivot socket further includes a reflector on the main body of the universal pivot socket, the reflector being made from reflective materials and attached using adhesive or fasteners, to enhance the visibility of the hand truck in low-light conditions or during nighttime use, thereby improving safety for the user.

13. The universal pivot socket of claim 7, wherein the inner sleeve is any reciprocal shape to the hollow interior of the outer socket, to the exterior shape of the connecting element intended to be affixed to the hand truck, or both.

14. The universal pivot socket of claim 7, wherein the flange has a curved or angled profile; is generally planar; adopts any shape that accommodates the hand truck or the connecting element intended to be fixed thereto; or a combination thereof.

15. The universal pivot socket of claim 7, wherein the circumference of the aperture is at least partially surrounded by a rib;
wherein the rib has a thickness that extends perpendicularly from the planar surface of the flange; and
wherein the rib is adapted to protect at least a portion of the fastener.

16. The universal pivot socket of claim 15, wherein the rib completely encircles the circumference of the aperture, the rib being reciprocally shaped to a nut of the fastener, such as to define a nut pocket.

17. The universal pivot socket of claim 7, wherein the inner sleeve includes one or more flexing portions located along at least a portion of one or both distal ends of the inner sleeve; and
wherein the one or more flexing portions are formed as a cutout, the one or more flexing portions are adapted to allow the diameter of the inner sleeve to fluctuate without breaking.

18. The universal pivot socket of claim 7, wherein the inner sleeve includes one or more retention tabs located along at least a portion of one or both distal ends of the inner sleeve; and
wherein the one or more retention tabs are formed as a projection that extends radially outward from the longitudinal axis of the inner sleeve, the one or more retention tabs are adapted to maintain the position of the inner sleeve within the outer socket once inserted therein.

19. The universal pivot socket of claim 18, wherein the one or more retention tabs engage one or both distal ends of the outer socket such that the one or more retention tabs at least partially extend past the one or both distal ends of the outer socket.

20. The universal pivot socket of claim 18, wherein the one or more retention tabs include a plurality of retention tabs; and
wherein the plurality of retention tabs is located around the circumference of both distal ends of the inner sleeve.
